(19) United States
(12) Patent Application Publication
(10) Pub. No.: US 2011/0262262 A1
(43) Pub. Date: Oct. 27, 2011

(54) Tray Device

(76) Inventors: Dan Solheim, Tempe, AZ (US); Uzra Vo, Phoenix, AZ (US)

(21) Appl. No.: 13/094,798

(22) Filed: Apr. 26, 2011

Related U.S. Application Data
(60) Provisional application No. 61/327,822, filed on Apr. 26, 2010.

(51) Int. Cl. B60N 3/10; B60R 7/00

(52) U.S. Cl. 414/800; 224/275

(57) ABSTRACT

A tray device suitable for being used on a seat backrest where the tray device has a platform, a mounting member for securing the platform to the seat backrest, a lateral mounting member, a receptacle, a portable member that allows for the platform to be transported, a platform stabilization member, and a storage member.

### CROSS-REFERENCE TO RELATED APPLICATION

This application claims the benefit of priority to U.S. Provisional Application No. 61/327,822, filed on Apr. 26, 2010, which is incorporated herein by reference in its entirety.

### BACKGROUND

Vehicle operators and their passengers are widely known to enjoy a beverage or transport multiple beverages while operating a vehicle. Many vehicles have two cup holders for supporting beverages. However, this is often an insufficient number.

Disposable cup holders fail to solve this problem because when placed on a seat a disposable cup holder will tilt towards the back of the seat causing the beverages therein to spill. In addition, it is sometimes necessary to use hands to secure either the disposable cup holder, or an individual beverage, causing the vehicle to be operated in a manner that places the life or the operator and the lives of others in jeopardy.

### SUMMARY OF THE INVENTION

One aspect of the invention is a tray device suitable for being used on a seat, where the seat has a seat backrest and the tray device has: a platform where the platform has a proximal end, a distal end, a proximal side, a distal side, a top surface, and a bottom surface; and a mounting member for securing the platform to the seat backrest, where the mounting member attaches to the platform and is suitable to attach to the seat backrest. In one embodiment, the platform has a receptacle. In another embodiment, the platform has a raised portion attached to the top surface of the platform, where the raised portion is elevated above the platform. In another embodiment, the mounting member has a mounting support and a vertical support, where the vertical support is attached to the platform and attached to the mounting support, and the mounting support is suitable to attach to the seat backrest. In another embodiment, the vertical support has a proximal support and a distal support, where the proximal support is attached to the proximal end of the platform and attached to the mounting support, and the distal support is attached to the distal end of the platform and attached to the mounting support. In another embodiment, the mounting member has a mounting support connector and two mounting member ends. In another embodiment, the mounting member also has a platform height adjustment member attached to the mounting support connector. In another embodiment, the tray device also has a lateral mounting member attached to the platform and is suitable to attach to the seat backrest. In another embodiment, the lateral mounting member has a lateral mounting support connector and two lateral mounting member ends. In another embodiment, the lateral mounting member has a lateral adjustment member. In another embodiment, the tray device has a portable member attached to the mounting member and the platform, where the portable member allows for the platform to be transported. In another embodiment, the portable member has a portable support and a handler, where the portable support is attached to a mounting support and attached to the platform. In another embodiment, the tray device has a portable member attached to the mounting member and the platform, and a one release member attached to the portable member and the mounting member, wherein the portable member allows for the platform to be transported and the release member allows the portable member to be disconnected from the mounting member. In another embodiment, the portable member has a portable support and a handler, wherein the portable support is attached to a mounting support and attached to the platform. In another embodiment, the portable support has: an adjustable support attached to the proximal end and distal end of the platform; and an adjustment member attached to the release member and connected to the adjustable support, where the adjustment member is attached to the release member and the adjustable support, and the adjustable support is connected to the adjustment member in a manner that allows the adjustable support to move freely through the adjustment member. In another embodiment, the portable support has a locking member attached to the adjustment member, where the locking member prevents the adjustment support from moving freely through the adjustment member. In another embodiment, the tray device has a platform stabilization member. In another embodiment, the tray device has a platform stabilization member comprising a pivot member operably interposed between the platform and the platform stabilization member, where the pivot member is rotationally coupled to the platform and rotationally coupled to the platform stabilization member. In another embodiment, the tray device has a storage member. In another embodiment, the storage member has the pivot member and the release member.

Another aspect of the invention is a method for supporting an item using the tray device that has: attaching the platform to the seat backrest, where the tray device has a mounting member for attaching the platform to the seat backrest; adjusting the platform height, where the tray device has a platform height adjustment member for adjusting the platform height; securing the platform to the seat backrest, thereby preventing the platform from moving in a lateral direction, where the tray device has a lateral mounting member for preventing the platform from moving in a lateral direction; and placing an item on the platform.

Another aspect of the invention is a method for carrying an item using the tray device that further has disconnecting the platform from the seat backrest, where the tray device has a release member for disconnecting the platform from the seat backrest; and carrying the platform, where the tray device has a portable member for transporting the platform.

Another aspect of the invention is a method for storing the tray device that has: disconnecting the platform from the seat backrest, where the tray device has a release member for disconnecting the platform from the seat backrest; and storing the platform, where the tray device has a storage member for storing the platform.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a front elevation view of the tray device according to an exemplary embodiment of the present invention.

FIG. 2 is a top plan view of the tray device according to an exemplary embodiment of the present invention.

FIG. 3 is a front elevation view of the portable member according to an exemplary embodiment of the present invention.

FIG. 4 is a top plan view of the platform according to an exemplary embodiment of the present invention.

FIG. 5 is a bottom plan view of the platform according to an exemplary embodiment of the present invention.

FIG. 6 is a top plan view of the platform according to an exemplary embodiment of the present invention.

FIG. 7 is a side plan view of the stabilization member according to an exemplary embodiment of the present invention.

### DETAILED DESCRIPTION

To aid in understanding aspects of the invention described herein, some terms used in this description are defined below.

By “proximal” is meant a location that is closest to the seat backrest.

By “distal” is meant a location that is farthest from the seat backrest.

By “lateral” is meant in a direction parallel with the plane of the platform.

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

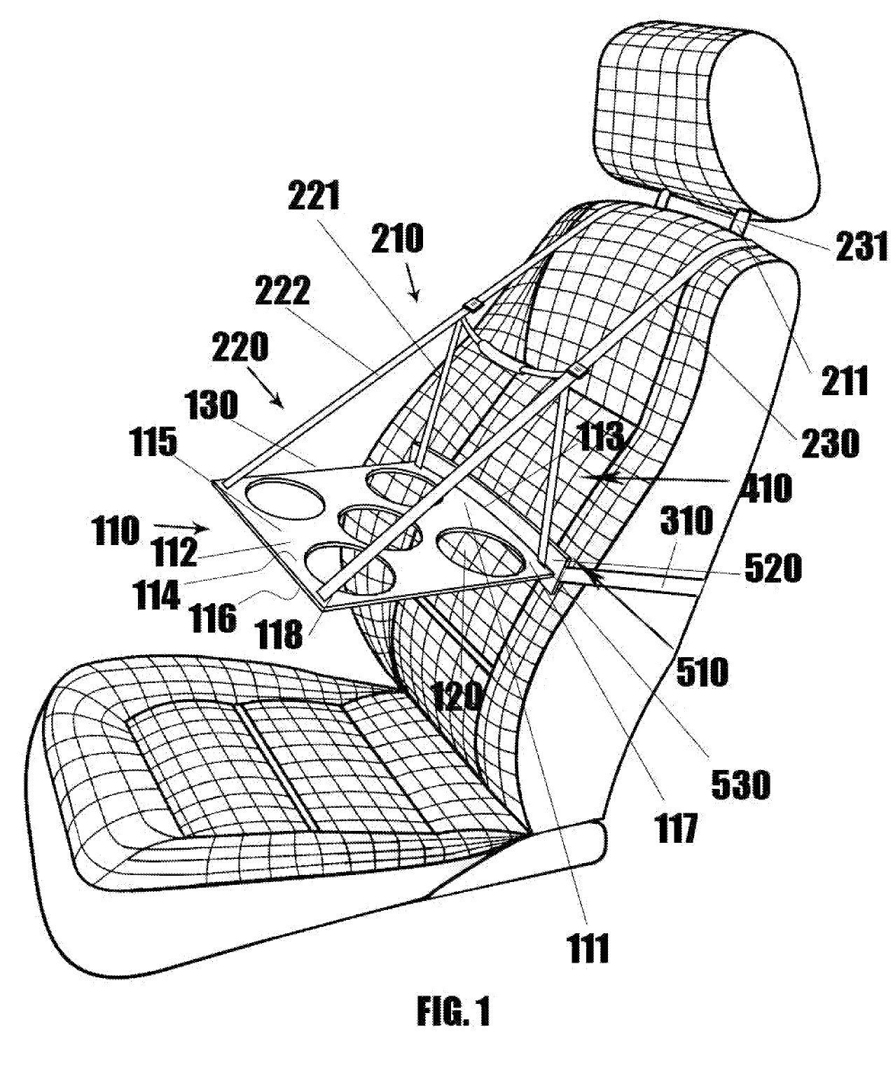

The subject invention pertains to a tray device 100 for mounting on the backrest of a seat. The tray device 100 can be used by an operator sitting in a second seat next to the mounted seat. In one embodiment of the invention, as illustrated in FIG. 1, the tray device 100 has a platform 110 and a mounting member 210. The tray device 100 can be mounted to all types of seats with a backrest, for example, without limitation, vehicle seats, stadium seats, theater seats, bleachers, or the like. The tray device 100 can be mounted to any location on a backrest, for example, without limitation, the forward facing surface, the rear facing surface, the side facing surface, or the like. In the preferred embodiment, the tray device 100 is mounted to the forward facing surface of a seat backrest in an automobile.

The platform 110 can support any item placed thereon, including placing food or beverages thereon to facilitate eating, placing a book thereon to facilitate reading or writing, placing paper thereon to facilitate writing, placing a laptop thereon to facilitate computer use, or the like. The platform 110 has a proximal end 111, a distal end 112, a proximal side 113, a distal side 114, a top surface 115, a bottom surface 116, a proximal corner 117, and a distal corner 118. The platform 110 can have any shape depending on the need of the user. The platform 110 can be any thickness that will provide support to the various items placed thereon. The platform 110 can be any length or width that can be mounted to a seat backrest. The length and width of the platform 110 can vary with the seat sizes. The platform 110 can be made of any rigid material, for example, without limitation, plastic, wood, metal, or the like. In the preferred embodiment, the platform 110 is of rectangular shape made of plastic with a thickness of 0.25 inches, a length of 11.5 inches, a depth of 10.5 inches.

In another embodiment, the platform 110 has at least one receptacle 120 used to secure a beverage. The receptacle 120 can be any conventional means in which to hold, secure, or contain a container, for example, without limitation, a cup holder, a recessed receptacle, an elevated receptacle, or the like. In the preferred embodiment, the receptacle 120 is a circular space in which a beverage container can be lowered into the circular space whereby the circumference of the circular space is incorporated into the platform 110 and thereby supports the beverage container. The receptacle 120 can be any size and shape, and can be a combination of sizes to provide for large and small beverage containers. The number of receptacles 120 in the platform 110 is only limited by the number of receptacles 120 that the platform 110 will hold while still supporting the beverage containers. The number of receptacles 120 will vary depending on the size of the platform 110. When the number of receptacles 120 exceeds one, the size of each receptacle 120 can vary in relation to each other or the receptacles 120 can be a uniform size. In one embodiment, the platform 110 has one large substantially rectangular receptacle 120 that holds a disposable beverage tray. In the preferred embodiment, the platform 110 has one small circular receptacle 120, two medium circular receptacles 120, and two large circular receptacles 120, where each receptacle 120 can hold a beverage container.

In another embodiment, the platform 110 has a raised portion (not shown) that rests on the top surface 115 of the platform 110 and follows the perimeter of the platform. The top of the raised portion is elevated above the platform 110. The raised portion prevents contents from sliding off the platform 110. The raised portion can be any height suitable to prevent an item from slipping off the edge of the platform 110 and can be made of any rigid material, for example, without limitation, plastic, wood, metal, rubber, or the like. In the preferred embodiment, the raised portion is 0.25 inches above the platform 110 and is made of plastic.

The mounting member 210 secures the tray device 100 to the seat backrest. The mounting member 210 attaches to the platform 110 and can attach to the seat backrest. The mounting member 210 can secure the tray device 100 to the seat in a variety of ways. In one embodiment, the mounting member 210 can have a continuous loop that is wrapped around the headrest supports 211. In one embodiment, the mounting member 210 can be made of inelastic material fit for a specific size headrest or an elastic material. In another embodiment, the mounting member 210 has a mounting support fastener (not shown) and two mounting member ends (not shown). The mounting support fastener can be secured to the two mounting member ends and can be any conventional fastener that connects two ends together. For example, without limitation, the mounting support fastener can be a male and female connector, a buckle, a clasp and buckle, a hook and loop, or the like. In the preferred embodiment, the mounting support fastener is a male and female connector. Also in the preferred embodiment, the mounting member 210 secures the tray device 100 to the seat backrest by extending the two mounting member ends around the backside of the headrest supports 211 and connecting them together with the mounting support fastener. In another embodiment, a securing device is attached to the mounting member 210 (not shown). The securing device can be any conventional means that connects a mounting member end to a headrest support 211, for example, without limitation, the securing device can be a clip, hook, hook and loop, or the like.

In one embodiment, the mounting member 210 has a vertical support 220 and a mounting support 230 where the vertical support 220 attaches to the platform 110 and the mounting support 230, and the mounting support 230 attaches to the seat backrest. In another embodiment, the vertical support 220 has a proximal support 221 and a distal support 222. The proximal support 211 attaches to the proximal end 111 of the platform 110 and the mounting support 230, and the distal support 222 attaches to the distal end 112 of the platform 110 and the mounting support 230.

In one embodiment, the mounting member 210 has at least one vertical support 220 and at least one mounting support 230. Similarly, the vertical support 220 has at least one proximal support 211 and at least one distal support 222. In the preferred embodiment, the mounting member 210 has two vertical supports 220 and two mounting supports 230. In this preferred embodiment, the two vertical supports 220 each have two proximal supports 221 and two distal supports 222. The two proximal supports 221 attach to the proximal end 111 of the platform 110 each at a different proximal corner 117 and the two distal supports 222 attach to the distal end 112 of the platform 110 each at a different distal corner 118. The mounting support 230 can attach to the seat backrest using the same embodiments and examples as described for attaching the mounting member 210 to the seat backrest.

In another embodiment, the mounting support 230 has a platform height adjustable member that enables tightening or loosening of the mounting support 230 thereby adjusting the length of the mounting support 230 and the height of platform 110. In one embodiment, the platform height adjustable member can be attached to the mounting support 230. In another embodiment, the platform height adjustable member can be attached to the mounting support connector. The platform height adjustable member can be any conventional means to tighten or loosen a support, for example, without limitation, a buckle, strap, hook, button, clip, or the like. In the preferred embodiment, the platform height adjustable member is a buckle.

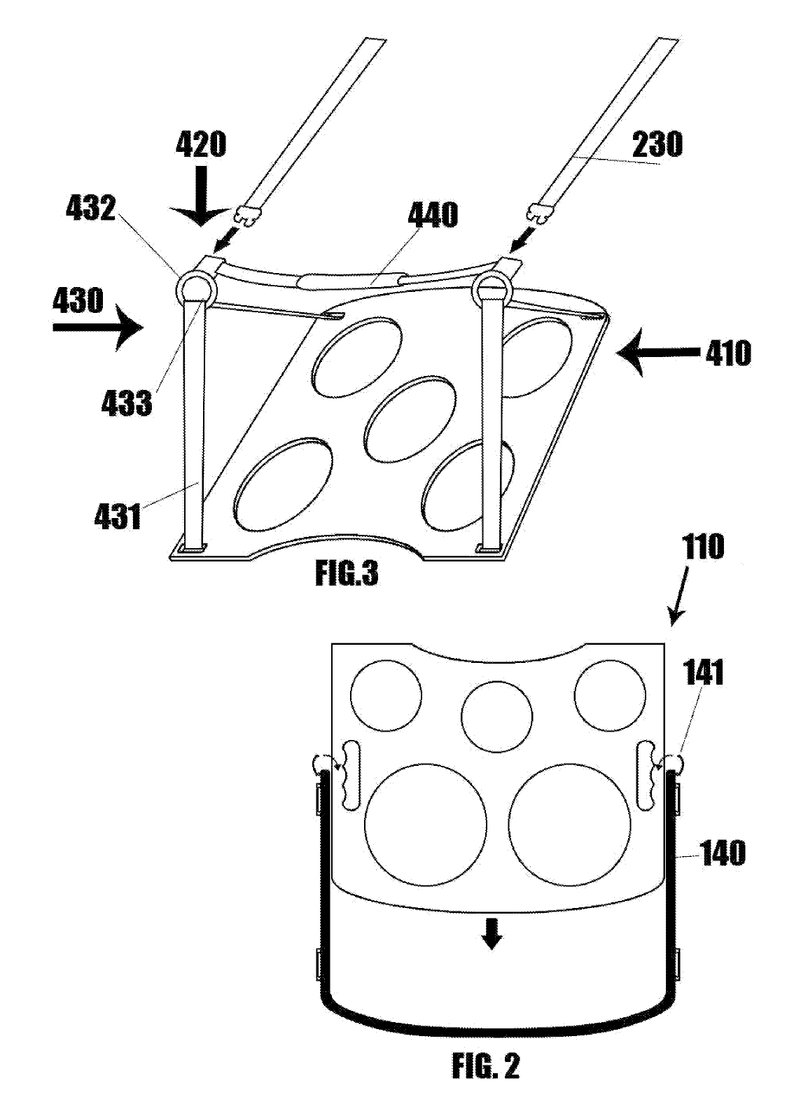

In another embodiment, the platform 110 has a sliding member 140 that enables the platform to horizontally slide away from and toward the seat backrest. As illustrated in FIG. 2, the sliding member 140 can be slidably attached to the platform and attached to the mounting member 210. In another embodiment, the sliding member 140 can have a sliding locking member 141 that prevents the platform from horizontally sliding. The sliding member 140 can be made of any rigid material, for example, without limitation, plastic, wood, metal, or the like. In the preferred embodiment, the sliding member 140 is in the form of a U-shape that runs the perimeter of the platform 110 and is made of plastic.

In another embodiment, the tray device 100 has a lateral mounting support 310 that attaches to the platform 110 and to the seat backrest. The lateral mounting support 310 secures the platform 110 to the seat backrest and prevents platform 110 from moving laterally. In one embodiment, the lateral mounting support 310 can be a continuous loop that is wrapped around the base of the seat backrest. In the preferred embodiment, the lateral mounting support 310 has a lateral mounting support connector (not shown) and two lateral mounting support ends (not shown). The lateral mounting support connector can be secured to the two lateral mounting support ends and can be any conventional fastener that connects two ends together. For example, without limitation, the lateral mounting support connector can be a male and female connector, a buckle, a clasp and buckle, a hook and loop, or the like. In this preferred embodiment, the lateral mounting support 310 secures the platform 110 to the seat backrest at a location that is parallel to the platform 110 by extending two lateral mounting support ends around the base of the seat backrest and connecting them together with the lateral mounting support connector.

In another embodiment, the lateral mounting support 310 has a lateral mounting support adjustment member (not shown) that enables tightening or loosening of the lateral mounting support 310, thereby securing or releasing the platform 110 to the seat backrest. In another embodiment, the lateral mounting support adjustment member can be attached to the lateral mounting support connector. The lateral mounting support adjustment member can be any conventional means to tighten or loosen a support, for example, without limitation, a buckle, strap, hook, button, clip, or the like. In the preferred embodiment, the lateral mounting support adjustment member is a clip.

In another embodiment, as illustrated in FIG. 3, the tray device 100 has a portable member 410 that can be used to transport the platform 110 and at least one release member 420 that allows for disconnecting the platform 110 from the seat backrest. The portable member 410 can have at least one portable support 430 and a handler 440. The portable support 430 can attach to the release member 420 and the platform 110. In one preferred embodiment, the portable support 430 can have an adjustable support 431, and an adjustment member 432. The adjustable support 431 attaches to the proximal end 111 and distal end 112 of the platform 110 and interacts with the adjustment member 432 in a manner that allows the adjustable support 431 to move freely through the adjustment member 432. The adjustment member 432 can be attached to the release member 420 and connected to the adjustable support 431. The handler 440 can be attached to the release member 420 and allows for the platform 110 to be lifted.

The release member 420 allows the adjustment member 432 to be disconnected from the mounting support 230, thereby releasing the platform 110 from the seat backrest. The release member 420 can attach to the mounting support 230 and to the adjustment member 432. The release member 420 can be any conventional fastener that connects two ends together. For example, without limitation, release member 420 can be a male and female connector, a buckle, a clasp and buckle, a hook and loop, or the like. In the preferred embodiment, the release member 420 is a male and female connector.

Once the release member 420 disconnects the portable member 410 from the mounting member 210, an operator can remove the portable member 410 from the seat backrest by lifting the handler 440. The adjustable support 431 can travel through the adjustment member 432 until the length of the adjustable support 431 between the adjustment member 432 and to the proximal end 111 of the platform 110 is substantially equal to the length of the adjustable support 431 between the adjustment member 432 and the distal end 112 of the platform 110. The approximate equal length of these two supports allows for the platform 110 and its contents to be carried in a level manner without the contents spilling.

In another embodiment, as illustrated in FIG. 5, the adjustable support 431 attaches to the platform 110 by passing through a distal platform hole 434 and a proximal platform hole 435, wherein the platform holes 434 and 435 allow the adjustable support 431 to slide along the bottom surface 116 until the length of the adjustable support 431, between the adjustment member 432 and to the proximal end 111 of the platform 110, is substantially equal to the length of the adjustable support 431 between the adjustment member 432 and the distal end 112 of the platform 110.

The adjustment member 424 can be any means that allows the adjustable support 431 to flow freely, for example, without limitation, a ring, loop, hook, bar, or the like. In the preferred embodiment, the adjustment member 424 is a ring and the adjustable support 431 is a strap.

In the preferred embodiment, portable member 410 has two portable supports 420 and a handler 440. In this preferred embodiment, one portable support 430 attaches to the one mounting support 230, the proximal end 111, and the distal end 112 and the other portable support 430 attaches to the other mounting support 230, the proximal end 111, and the distal end 112. The use of two portable supports 230 provides greater stability for carrying the items placed on the platform 110.

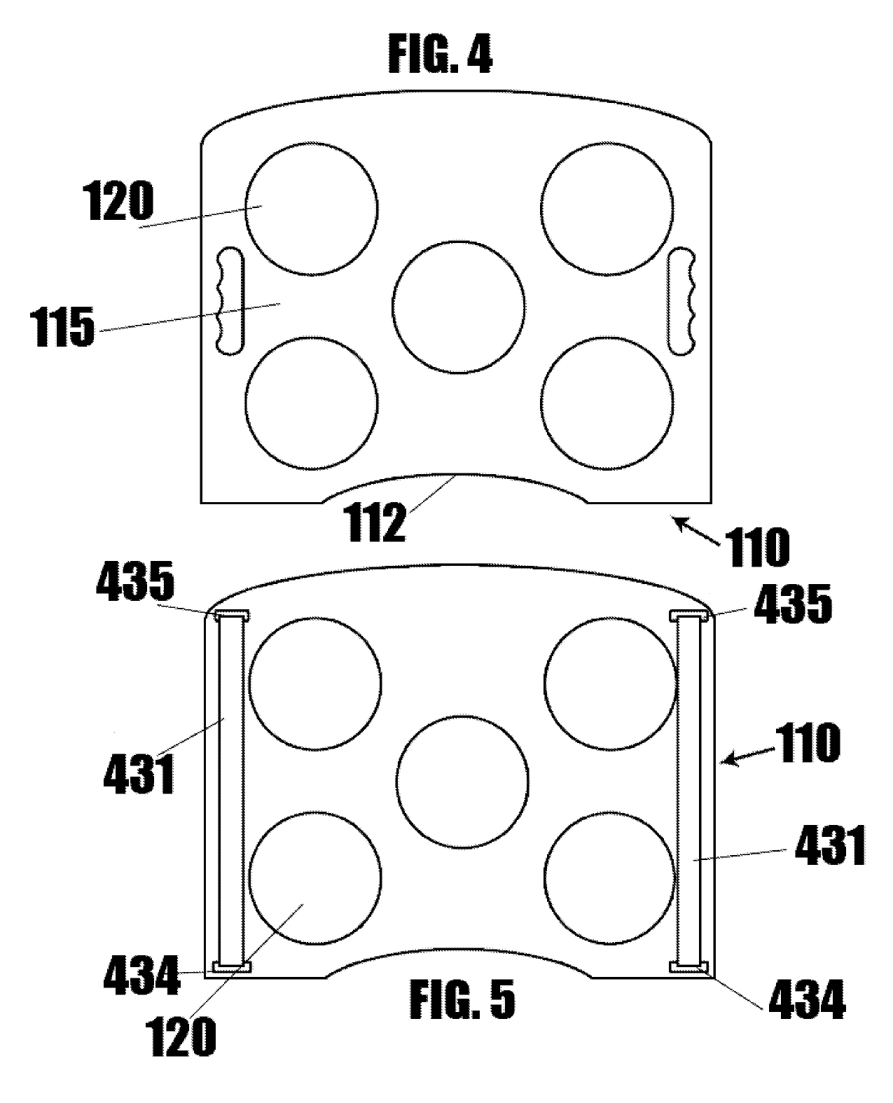

The handler 440 can attach to the release member 420 of both portable supports 420. In another embodiment, as shown in FIG. 4, the handler 440 is two handles attached to or integrated into the platform 110.

Also in the preferred embodiment, the portable support 430 has a locking member 433 attached to the adjustment member 432. The locking member 433 can be any means that prevents the adjustable support 431 from moving freely through said adjustment member 432. For example, without limitation, the locking member 433 can be a locking bar, a hook, buckle, hook and loop, ring, eyelet, eyelet/ring, or the like. In the preferred embodiment, the locking member 490 is an eyelet/ring.

FIG. 4 demonstrates another embodiment wherein the distal side 112 can be curved allowing the platform to rest against the hip of the carrier in a comfortable fashion.

The mounting member 210, mounting support 230, vertical support 220, proximal support 211, distal support 222, portable support 430, adjustable support 431, handler 440, and lateral mounting support 310, can be made of a variety of sturdy material, for example, without limitation, elastic material, inelastic material, nylon fabric, plastic, leather, or the like. In the preferred embodiment, said means and supports are made of nylon fabric.

The mounting member 210, vertical support 220, the proximal support 211, distal support 222, adjustable support 431, portable support 430, and lateral mounting support 310 can attach to the platform 110 by conventional means, for example, without limitation, sewing, gluing, screwing, nailing, or the like. In the preferred embodiment, said means and supports attach to the platform 110 by sewing.

The mounting support connector, securing device, platform height adjustment member 231, lateral mounting support connector, lateral mounting support adjustment member, release member 420, adjustment member 432, and locking member 433 can be made of a variety of sturdy material for example, without limitation, plastic, wood, metal, or the like. In the preferred embodiment, said means and connectors are made of plastic.

In one embodiment, the tray device 100 has a platform stabilization member 510. The platform stabilization member 510 can be any means that increases the friction between the platform 110 and the seat backrest, thereby stabilizing the platform 110 and ensuring the platform 110 remains at a level pitch. In one embodiment, the platform stabilization member 510 connects to the platform 110 and rests against the seat backrest. In another embodiment, the platform stabilization member 510 can connect to the platform 110 and the vertical support 220, and can rest against the seat backrest.

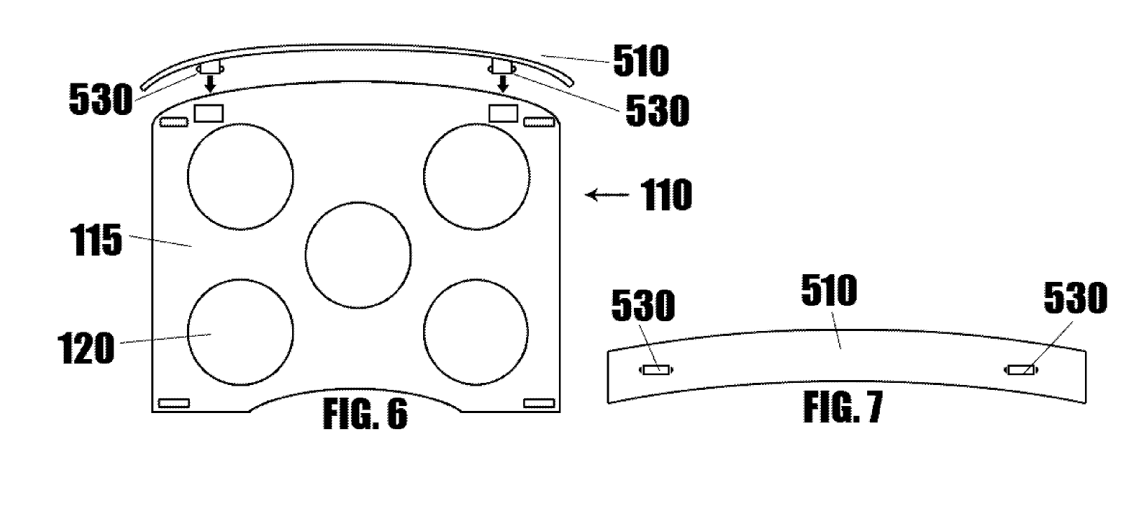

In the preferred embodiment, the platform stabilization member 510 connects to the proximal side 111 of the platform 110 and the adjustable support 431, and rests against the seat backrest. In this preferred embodiment, the platform stabilization member 510 can be a back plate. The back plate can have any shape and thickness that will provide stabilization to the platform 110. The back plate can be any length or width that can be attached to the platform 110 and will vary depending on the size of the platform 110. The back plate can be made of any rigid material, for example, without limitation, plastic, wood, metal, or the like. In the preferred embodiment, the back plate is an arcuate, curved rectangular shape, as illustrated in FIGS. 6 and 7, made of plastic with a thickness of 0.25 inches, a length of 11.5 inches, a depth of 3 inches.

In another embodiment, the platform stabilization member 510 can be any friction creating material that lines the proximal side of the platform 110. For example, without limitation, the friction creating material can be rubber, plastic, or the like.

In another embodiment, the platform stabilization member 510 can be any friction creating surface that is incorporated into the proximal side of the platform 110. For example, without limitation, the friction creating surface can be bumps.

In another embodiment, the tray device 100 has a pivot member 530 that is operably interposed between the platform 110 and the platform stabilization member 510, thereby rotationally coupling the platform 110 to the platform stabilization member 510. The pivot member 530 pivotally attaches the platform 110 to the platform stabilization member 510. The pivot member 530 allows the platform stabilization member 510 to adjust to the angle of the seat backrest thereby changing the angle of the platform stabilization member 510 and allowing the platform stabilization member 510 to rest against the seat backrest in a flush manner. This further increases the friction between the platform 110 and the seat backrest and further ensures the platform 110 remains at a level pitch. The pivot member 530 can be any means that connects the platform 110 with the platform stabilization member 510 in a manner that allows the platform 110 and the platform stabilization member 510 to pivot in relation to each other. For example, without limitation, the pivot member 530 can be at least one hinge. The pivot member 530 can be made of a variety of material, for example, without limitation, metal, plastic, or the like. In the preferred embodiment, the pivot member 530 has two hinges made of metal.

In another embodiment, the tray device 100 has a storage member (not shown) that allows the tray device to be folded up and stored in a narrow location. The storage member can have the pivot member 530 and the release member 420. The storage member allows for the platform stabilization member 510 to pivot so it lays flush with the platform 110 thereby allowing the tray device 100 to be stored in a narrow location. For example, without limitation, the tray device 100 can be stored in a bag, next to the seat, in a seat backrest compartment, or the like. In the preferred embodiment, the tray device 100 is stored under a seat.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A tray device suitable for being used on a seat, wherein said seat comprises a seat backrest and said tray device comprises:
a platform, wherein said platform comprises a proximal end, and a distal end, and
a mounting member for securing said platform to said seat backrest,
wherein said mounting member attaches to said platform and is suitable to attach to said seat backrest.

2. The tray device of claim 1 wherein said platform further comprises a receptacle.

3. The tray device of claim 1 wherein said platform further comprises a raised portion attached to a top surface of said platform, wherein said raised portion is elevated above the platform.

4. The tray device of claim 1 wherein said mounting member comprises a mounting support and a vertical support, wherein said vertical support is attached to said platform and attached to said mounting support, and said mounting support is suitable to attach to said seat backrest.

5. The tray device of claim 4 wherein said vertical support comprises a one proximal support and a one distal support, wherein said proximal support is attached to said proximal end of said platform and attached to said mounting support, and said distal support is attached to said distal end of said platform and attached to said mounting support.

6. The tray device of claim 1 wherein said mounting member comprises a mounting support connector and two mounting member ends.

7. The tray device of claim 6 wherein said mounting member further comprises a platform height adjustment member attached to said mounting support connector.

8. The tray device of claim 1 further comprising a lateral mounting member attached to said platform and is suitable to attach to said seat backrest.

9. The tray device of claim 8 wherein said lateral mounting member comprises a lateral mounting support connector and two lateral mounting member ends.

10. The tray device of claim 9 wherein said lateral mounting member further comprises a lateral adjustment member.

11. The tray device of claim 1 further comprising a portable member attached to said mounting member and said platform, and a release member attached to said portable member and said mounting member, wherein said portable member allows for said platform to be transported and said release member allows said portable member to be disconnected from said mounting member.

12. The tray device of claim 11 wherein said portable member further comprises a portable support and a handler, wherein said portable support is attached to a mounting support and attached to said platform.

13. The tray device of claim 12 wherein said portable support comprises:
an adjustable support attached to the proximal end and distal end of the platform, and
an adjustment member attached to said release member and connected to said adjustable support,
wherein said adjustment member is attached to said release member and said adjustable support, and said adjustable support is connected to said adjustment member in a manner that allows said adjustable support to move freely through said adjustment member.

14. The tray device of claim 13 wherein said portable support further comprises a locking member attached to said adjustment member, wherein said locking member prevents said adjustment support from moving freely through said adjustment member.

15. The tray device of claim 1 further comprising a platform stabilization member.

16. The tray device of claim 11 further comprising a platform stabilization member comprising a pivot member operably interposed between said platform and said platform stabilization member, wherein said pivot member is rotationally coupled to said platform and rotationally coupled to said platform stabilization member.

17. The tray device of claim 1 further comprising a storage member.

18. The tray device of claim 16 wherein said storage member comprises said pivot member and said release member.

19. A method for supporting an item using said tray device of claim 1 wherein said method comprises:
attaching said platform to said seat backrest, wherein said tray device comprises a mounting member for attaching said platform to said seat backrest,
securing said platform to said seat backrest, thereby preventing said platform from moving in a lateral direction, wherein said tray device comprises a lateral mounting member for preventing said platform from moving in a lateral direction, and
placing an item on said platform.

20. A method for carrying an item using said tray device of claim 1, wherein said method further comprises:
disconnecting said platform from said seat backrest, wherein said tray device comprises a release member for disconnecting said platform from said seat backrest, and
carrying said platform, wherein said tray device comprises a portable member for transporting said platform.
